(19) United States
(12) Patent Application Publication
(10) Pub. No.: US 2012/0193017 A1
(43) Pub. Date: Aug. 2, 2012

(54) METHOD AND DEVICE FOR SEALING TUBULAR PLASTIC PACKAGING, AND RESULTING PACKAGING

(76) Inventors: Gerhard Keller, Vouvry (CH); Jacques Thomasset, Vouvry (CH)

(21) Appl. No.: 13/388,191

(22) PCT Filed: Jul. 31, 2009
(86) PCT No.: PCT/IB2009/053346

§ 371 Date: Apr. 16, 2012

(51) Int. Cl. B32B 37/02; B32B 37/12; B32B 37/10

(52) U.S. Cl. 156/184; 156/349; 156/580

(57) ABSTRACT

Method for welding a tubular plastic container, comprising at least the following operations:
a. a winding operation in which a laminate (11) is wound,
b. a positioning operation in which the ends (8, 9) of the laminate (11) are positioned next to one another,
c. an extrusion operation in which a softened resin string (12) is extruded and deposited on the said ends (8, 9),
d. a fusion operation in which the said ends (8, 9) are fused by means of the said string (12),
e. a compression operation in which the weld zone (10) is compressed,
f. a cooling operation in which the weld is cooled.

### FIELD OF THE INVENTION

The invention relates to the field of flexible tubes formed using plastic films. It relates more particularly to a flexible tube formed using a film of which the ends are welded by the addition of a softened weld string.

### PRIOR ART

Welding by addition of a softened plastic string is described in patent application WO 2008/038206 A2. In this method filed by the applicant, the weld string is extruded and welded to each end of the laminate and serves as a bond between the said ends. The temperature of the weld string is sufficiently high to ensure its welding to the said ends, so that no additional energy input is required. The method has the advantage of improving the attractiveness of the tubes because the string is applied to the surface forming the inner face of the container. Another advantage is the simplicity of the device in comparison with the high frequency welding devices generally used.

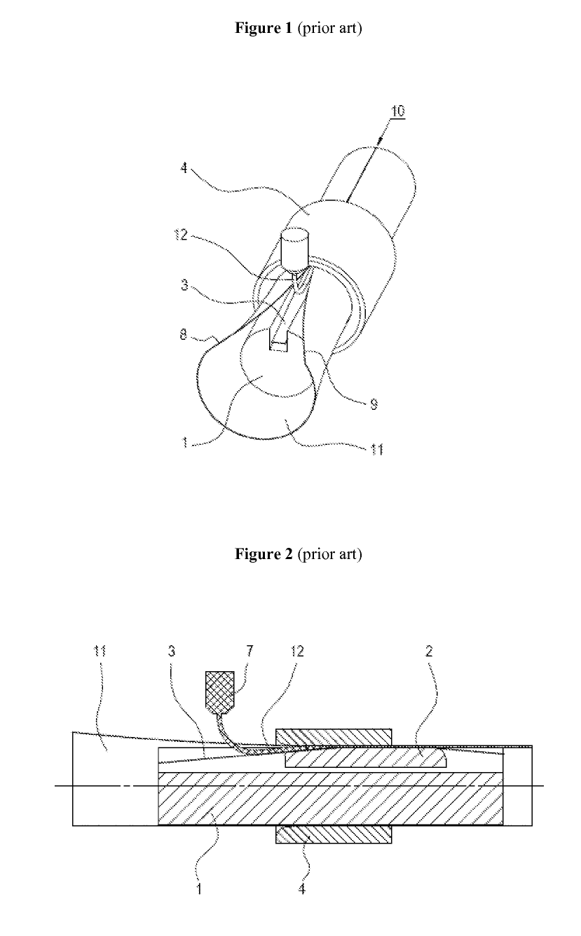

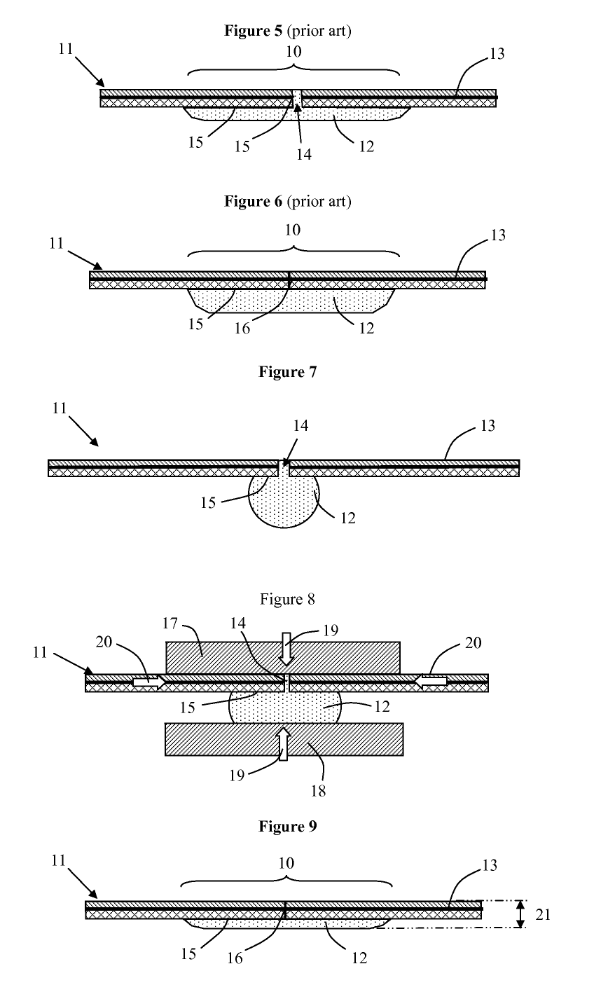

However, the method and the device described in patent application WO 2008/038206 A2 have a number of drawbacks relative to the containers produced. These drawbacks are associated with the appearance of three types of weld defect on the containers. The first defect is aesthetic and appears when the ends of the laminate are not joined. In this case, the weld string is visible from outside the container. An illustration of this type of weld is shown in FIG. 5. The ends of the laminate 11 are not joined and the space 14 between the said ends is filled by the weld string 12. This type of weld has a second defect when the laminate 11 comprises a barrier layer 13. A loss of barrier properties is observed in the weld zone 10, due to the break in the layer 13. The loss of properties is commensurate with the size of the space 14. The loss of the barrier properties of the container is significant when the ends of the laminate are not joined or are insufficiently welded. The third defect is mechanical and appears when the ends are joined but are not welded together. This type of weld, shown in FIG. 6, is obtained with the devices described in the prior art and shown in FIGS. 1 to 4. In this case, a very thick weld string 12 is required to compensate for the low strength of the butt weld of the laminate 11. The weld zone 10 has a first zone 15 formed by the interface between the string 12 and the laminate 11, and a second zone 16 formed by the interface between the ends of the laminate. It is observed that the methods and devices described in the prior art are incapable of welding the interface 16. The high thickness of the weld string 12 reduces the flexibility of the container at the weld zone. The unwelded interface 16 between the ends of the laminate also penalises the aesthetic and barrier properties of the container. The appearance of the abovementioned defects stems from the difficulty of softening the ends of the laminate using the energy supplied by the weld string.

The method and device described in application WO 2008/038206 A2 and shown in FIGS. 1 to 4 also have other drawbacks which result in particular from the fact that the softened string flows naturally downwards under the action of gravity. Accordingly, the string first enters into contact with the surface of the welding rod or, if applicable, the drive belt built into the rod. In FIG. 2, which shows a cross section of the device shown in FIG. 1, the weld string 12 is placed on a metal belt 3 before coming into contact with the laminate 11. This first contact of the string, of which the temperature is relatively high, with a cold metal surface, is detrimental to the operation of the method. This is because the string temperature is lowered before coming into contact with the edges of the laminate to be welded. This accidental loss of energy substantially reduces the quality of the weld.

### GENERAL SUMMARY OF THE INVENTION

The problem that the present invention proposes to solve resides in improving the quality of the weld obtained using a softened extruded string. The invention also serves in particular to remedy the abovementioned drawbacks.

The invention relates primarily to a method for welding a tubular plastic container, comprising at least the following operations:
a winding operation in which a laminate is wound,
a positioning operation in which the edges of the laminate are positioned,
an extrusion operation in which a softened plastic string is extruded and deposited on the ends of the laminate,
a fusion operation in which the said ends are fused by means of the weld string,
a compression operation in which the weld zone is pressed jointly in two directions,
a cooling operation of the weld zone.

The said fusion operation is a key point of the invention, because it serves to soften the surface of the ends of the laminate. The fusion of the ends of the laminate is obtained thanks to the thermal energy of the weld string and is implemented in such a way that:
the string is only in contact with the ends of the laminate,
the duration of the operation and the energy of the weld string are sufficient to soften the said ends.

The said compression operation, which is simultaneous with or follows the fusion step, consists in:
very rapidly compressing the weld string along a perpendicular axis of the laminate,
and jointly pressing the softened ends of the laminate against one another in a direction parallel to the plane of the laminate.

The implementation of the invention leads to a method consisting in moving the string in a direction parallel to the elements of the device likely to enter into contact with the string. In this way, the string has no contact with elements such as the rod or belt before coming into contact with the laminate.

The invention is characterized in that the string is moved parallel to the welding device, in particular to the rod, and optionally to the belt, so that the first contact of the string occurs with the laminate.

One feature of the invention resides in the fact that all the energy required to execute the weld originates from the plastic string.

According to a first alternative of the inventive method, the string is deposited prior to the positioning step.

According to a second alternative, the string is deposited during the positioning step.

According to a third alternative, the string is deposited following the positioning step.

The string may be deposited on the surface of the laminate forming the inner face of the container or on the face forming the outer surface. Preferably, the string is deposited on the surface forming the inner face.

The invention further relates to a device for carrying out a method as defined above. The device comprises a welding rod adapted to be surrounded by a laminate, means for extruding and placing a softened plastic string between the outer surface of the welding rod and a laminate placed around the said rod, the device being characterized in that the rod is positioned vertically.

The container comprises a weld zone comprising two distinct portions:
a first welded portion formed by the interface between the abutting ends of the laminate,
a second portion formed by the interface between the underside of the laminate and the weld string.

The weld has a total thickness less than twice the thickness of the laminate and preferably less than 1.8 times the thickness of the laminate. The strength of the weld zone is greater than the strength of the laminate.

When the laminate comprises a plurality of layers, the invention is advantageous for improving the continuity of the layers in the weld zone. In consequence, the barrier properties of these containers are improved, and also the attractiveness of the weld zone.

An alternative of the invention consists in using the method to execute a weld by overlapping the ends of the laminate. In this case, the weld string is positioned at the interface of the ends of the laminate intended to overlap. The fusion operation serves to soften the said ends.

In the case in which the laminate, in its thickness, comprises a layer which slows down the diffusion of the heat, such as an aluminium layer or a paper layer, it may be advantageous to use a device for preheating the edges, for example by contact, which has the effect of raising the temperature of the two edges of the laminate, thereby facilitating or improving the welding conditions.

According to an alternative of the invention, the edges of the laminate are cut on the bias, which has the effect of increasing the lateral contact area of the laminate in the weld zone. Such a configuration also influences the quality and strength of the weld.

Another alternative of the invention consists in using a co-extruded plastic string (with a barrier material at the centre of the string), also to guarantee good barrier protection with the external environment of the tube in the zone defined between the edges of the laminate.

### DETAILED SUMMARY OF THE INVENTION

The invention is described in greater detail below by means of examples illustrated in the following figures:

FIG. 1 shows a perspective view of a device of the prior art.

FIG. 2 shows a lateral cross section of the device in FIG. 1.

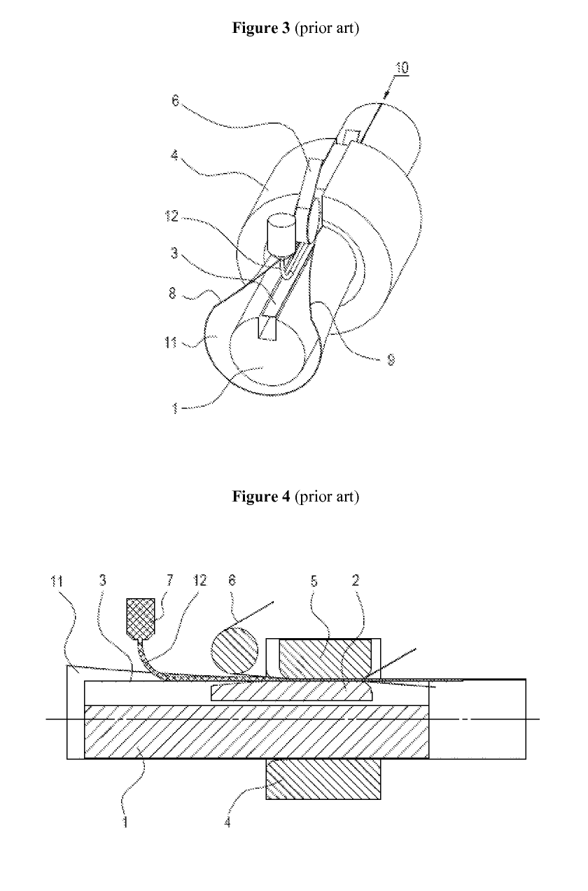

FIG. 3 shows a perspective view of a second device of the prior art.

FIG. 4 shows a lateral cross section of the device in FIG. 3.

FIG. 5 shows a first alternative of a prior art weld.

FIG. 6 shows a second alternative of a prior art weld.

FIGS. 7 and 8 show a butt welding method according to the invention.

FIG. 7 shows the fusion operation of the method.

FIG. 8 shows the compression operation of the method.

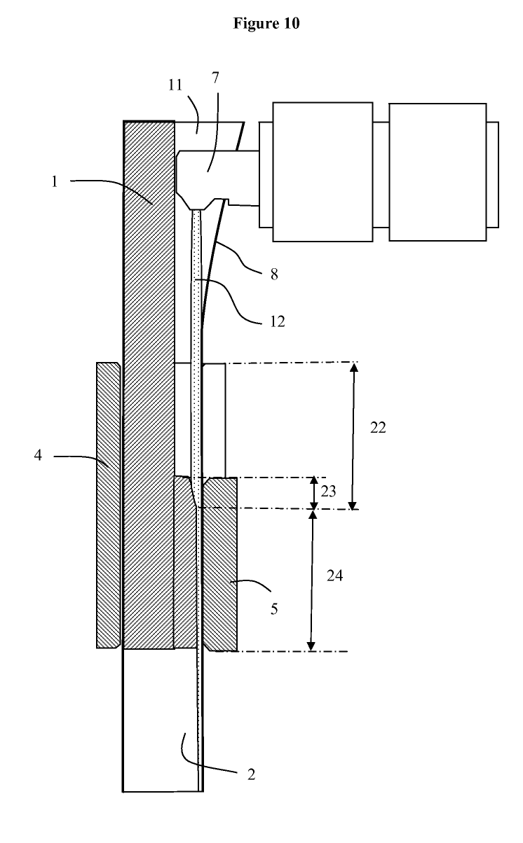

FIG. 9 shows a butt weld according to the invention.

FIG. 10 shows a cross section of a device according to the invention.

FIG. 11 shows a cross section of the device in the fusion operation.

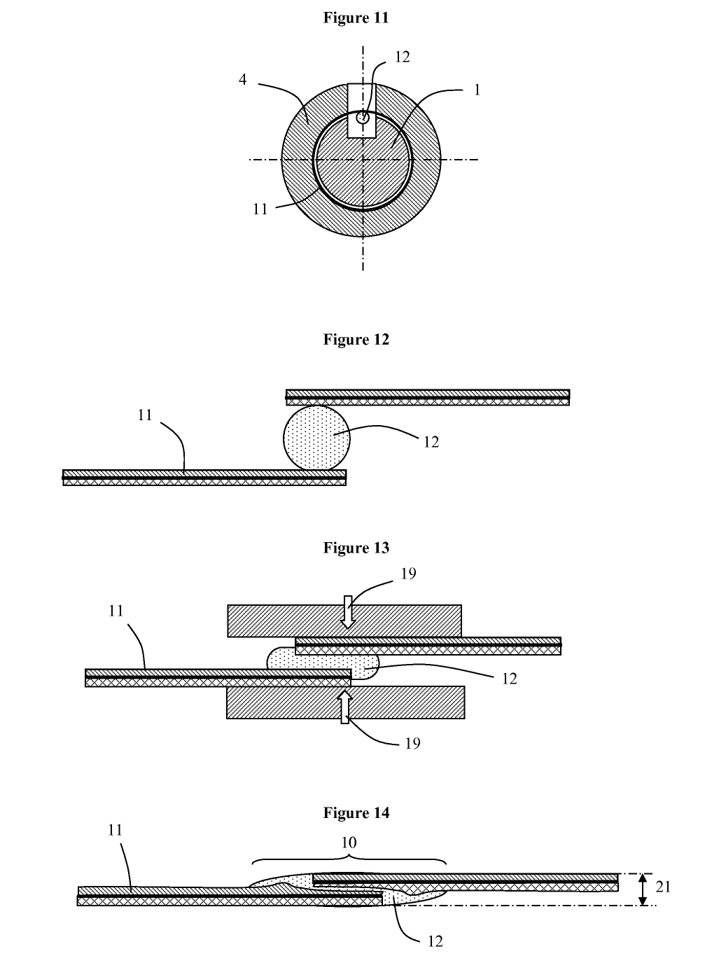

FIGS. 12 and 13 show the method for a weld with overlap.

FIG. 12 shows the fusion operation.

FIG. 13 shows the compression operation.

FIG. 14 shows a weld with overlap according to the invention.

### LIST OF REFERENCE NUMERALS USED IN FIGS. 1 TO 9

1. Welding rod
2. Sizing die (adjustable height)
3. Internal belt (metal)
4. Shaping die
5. Bearing pad
6. Outer belt
7. Extruder head
8. First edge of laminate
9. Second edge of laminate
10. Weld zone
11. Laminate (continuous strip)
12. Extruded plastic string
13. Barrier layer
14. Space
15. String-laminate interface
16. Laminate-laminate interface
17. External compression element
18. Internal compression element
19. Compression force perpendicular to laminate surface
20. Compression force parallel to laminate surface
21. Thickness of weld zone
22. Fusion zone
23. Compression zone
24. Cooling zone

The inventive method consists in using the energy contained in the weld string to:
weld the string to the ends of the laminate,
weld the ends of the laminate to one another.

The weld zone thus comprises two distinct portions, the first being formed by the string-laminate interface and the second by the laminate-laminate interface.

The inventive method comprises at least the following operations:
Winding the laminate to form a tubular body,
Positioning the ends of the laminate,
Extruding and depositing a weld string on the said ends,
Fusing the said ends using the energy of the said string,
Compressing the weld zone,
Cooling the weld zone,
Cutting the tubular body into cylindrical elements of identical length.

The key steps of the inventive method are shown in FIGS. 7 and 8. FIG. 7 shows the fusion operation in which part of the energy of the weld string is transferred to the laminate to soften the ends to be welded. The softened extruded weld string 12 is contacted with the ends of the laminate 11. The interface 15 between the string and the laminate has a reduced area in order to heat only the ends to be welded. During the said fusion operation, the weld string 12 is only in contact with the ends of the laminate 11. According to a preferred embodiment of the invention, the ends of the laminate 11 are only in contact with the weld string 12 during the fusion operation. The absence of external contact with the weld string 12 and the ends of the laminate during the fusion operation is a key feature of the invention. The duration of the fusion operation depends on the thickness of the laminate and the temperature and mass of the weld string. The duration of the fusion operation is generally longer than 0.1 second and the temperature of the weld string is at least 50° C. higher than the melting point. It is generally attempted to reduce the mass of the weld string to decrease the thickness of the weld as well as the cost of the container. The optimal mass results from a compromise between the minimum energy that the string must contain during the fusion operation, the thickness of the weld that is to be reduced and, finally, the properties of the weld zone. These parameters are adjusted by a person skilled in the art. When the laminate 11 is a multilayer laminate, it is not always possible and useful to soften all the layers. In this case, the energy supplied by the weld string 12 is used to soften the layers suitable for butt welding. In general, the resin constituting the weld string is of the same type as the welding layers of the laminate. It is advantageous for the weld string 12 to select a resin having a melting point equal to or higher than that of the resins constituting the welding layers of the laminate. For example, the use of a high density polyethylene weld string is advantageous for making tubes with a laminate comprising layers of low density polyethylene. The fusion operation may be prior to or simultaneous with the compression operation.

It may occur that the laminate, in its thickness, contains layers slowing down the heat transfer between the weld string and the welding layers of the laminate. For example, it has been observed that an aluminium layer or a paper layer considerably slows down the heat transfer. It sometimes becomes difficult to soften the layers located close to the upper surface of the laminate, since the weld string is located on the lower surface. To overcome this difficulty, the addition of a heat source to the outer surface of the laminate during the fusion operation can be considered. Heating the upper surface by contact or by hot air is advantageous in this case.

Successively or simultaneous with the fusion operation, the weld zone is compressed. The compression operation shown in FIG. 8 consists in:
Reducing the thickness of the weld string and pressing the softened interface 15 between the laminate 11 and the weld string 12,
Reducing the space 14 between the ends and pressing the interface 16 between the softened ends of the laminate 11.

During the compression operation, the weld zone 10 is pressed jointly along a direction called perpendicular and a direction called transverse. The perpendicular direction is perpendicular to the plane formed by the weld zone. The direction called transverse is parallel to the plane formed by the weld zone and perpendicular to the weld axis. The perpendicular pressure decreases the thickness of the weld string 10 and increases the cohesion of the welded interface between the string 12 and the laminate 11. The perpendicular pressure is provided by means of an external pressure element 17 in contact with the outer surface of the laminate and an internal pressure element 18 in contact with the weld string. The compressive force 19 applied by the compression elements 17 and 18 causes the reduction of the thickness of the weld string and causes it to spread. The compression operation must be very rapid to avoid cooling the weld zone 10, which would prevent the crushing of the string 12 and would give rise to a poor quality welded interface 15 between the string and the laminate. Prior to, jointly with or after the perpendicular compression, the weld zone is pressed transversely under the effect of a transverse compressive force 20 applied to the laminate. The transverse compressive force 20 brings the edges of the laminate together and presses the softened edges of the laminate 11 at the welded interface 16. This transverse compression improves the cohesion of the weld at the interface 16. The transverse compressive forces 20 have a low intensity and are transmitted by the laminate to the interface 16. The compression of the interface 16 has the effect of substantially increasing the strength of the weld zone and improves the continuity of the barrier properties of the laminate in the weld zone.

FIG. 9 shows a butt weld of the method. The weld zone 10 has two distinct weld zones:
the interface 15 between the string 12 and the underside of the laminate 11,
the interface 16 between the ends of the laminate.

Contrary to the welds obtained with the methods and devices described in the prior art, the interface 16 between the ends of the laminate 11 is welded. The distance between the ends of the barrier layer is shorter than 60 microns and preferably shorter than 30 microns. In consequence, the properties of the container are improved, that is:
better continuity of the barrier and mechanical properties at the weld zone,
lower thickness of the weld.

In comparison with the prior art welds, the thickness 21 of the weld can be reduced. The thickness of the weld 21 according to the invention is advantageously lower than twice the thickness of the laminate. Preferably, this thickness is lower than 1.8 times the thickness of the laminate.

FIG. 10 shows a device according to the invention. The tube is formed continuously by progressive envelopment of the welding rod 1 over the whole circumference with a strip of laminate 11 pulled from top to bottom across the shaping die 4. The laminate 11 of PE or PP (or other materials) (single- or multilayer) is then welded longitudinally by depositing a softened extruded plastic string 12 inside the tube. As shown in FIG. 10, the welding rod 1 is positioned vertically. In this way, the string 12, which also moves vertically, does not come into contact with the rod 1 but directly with the laminate 11.

The device comprises a zone 22 called a fusion zone for carrying out the fusion operation of the method. The length of the zone 22 is defined according to the thickness of the laminate and the travel speed of the laminate. In the fusion zone 22, the ends of the laminate and the softened weld string 12 are kept in contact. The string 12 and the ends of the laminate have no other contact with the elements of the device in the fusion zone 22.

The device comprises a zone 23 called compression zone for carrying out the compression operation. The zone 23 is shorter because the compression operation must be of short duration. In the zone 23, the weld zone is pressed jointly along a direction called perpendicular and along a direction called transversal. The perpendicular compression which presses the weld string 12 and causes it to spread is shown in FIG. 10. The weld zone is pressed between the bearing pad 5 applying a pressure to the outer face of the laminate and by the sizing die 2 applying a pressure to the weld string. The compression zone 23 is short so that the compression operation is of short duration. Many other compression means than those shown in FIG. 10 can be used. Press rolls may be advantageous when the resins constituting the weld string 12 or the outer surface of the laminate create deposits on the compression tools. The compression tools are preferably cooled. Another alternative is to use belts travelling at the same speed as the laminate and coming into contact with the weld zone at the time of compression. This alternative serves to avoid friction between the weld zone and the tools during the compression and cooling operations. Some devices use a single belt placed on the outer or inner face of the weld. Other devices have two belts positioned on either side of the weld zone and coming into contact with the said zone only at the time of the compression operation. The device shown in FIG. 10 also applies a transverse compressive force which presses the softened edges of the laminate. The transverse pressure is applied by the shaping die 4 of which the geometry in the compression zone has the effect of gently pressing the ends of the laminate. Advantageously, in the compression zone, the diameter of the shaping die 4 is slightly lower than the diameter of the tubular body formed by the outer surface of the laminate 11.

The device comprises a zone 24 called a cooling zone for carrying out the cooling operation. In this zone, the weld is cooled between the bearing pad 5 and the sizing die 2. In the cooling zone, elements may also be added to improve the roundness of the tubes produced. The length of the cooling zone 24 is generally reduced because the heated zone is local. The length of the zone 24 is adjusted according to the thickness of the laminate, of the weld string, and of the travel speed of the laminate.

FIG. 11 shows a cross section of the device at the fusion zone 22. FIG. 11 shows that the softened weld string 12 is only in contact with the ends of the laminate 11. The weld string 12 has no contact with the rod 1, and the shaping die 4. The vertical positioning of the device is particularly advantageous to avoid any contact of the weld string 12 with the tools during the production of the tubular body, but also during the starting and stopping phases.

FIGS. 12 to 14 show an alternative of the invention in which the ends of the laminate are welded with an overlap.

FIG. 12 shows the method at the time of the operation called fusion. During the fusion operation, the weld string 12 is positioned between the overlapping ends of the laminate 11. Part of the energy of the string 12 is transmitted to the said ends to soften them.

FIG. 13 shows the operation called compression during which a compressive force 19 is applied perpendicular to the surface of the laminate. This compressive force has the effect of reducing the thickness of the string 12 and covering the ends of the laminate 11.

FIG. 14 shows an overlap weld executed according to the invention. The weld zone 10 has a thickness 21 lower than twice the thickness of the laminate and preferably lower than 1.8 times the thickness of the laminate 11. The weld string 12 covers the edge of the laminate at the welded edges.

The use of a softened co-extruded weld string (with a barrier material at the centre of the string) serves to improve the barrier protection at the weld zone.

1. Method for welding a tubular plastic container, comprising at least the following operations:
a. a winding operation in which a laminate is wound,
b. a positioning operation in which the ends of the laminate are positioned next to one another,
c. an extrusion operation in which a softened resin string is extruded and deposited on the said ends,
d. a fusion operation in which the said ends are fused by means of the said string,
e. a compression operation in which the weld zone is compressed,
f. a cooling operation in which the weld is cooled.

2. Method according to claim 1, in which the said ends are positioned abutting one another.

3. Method according to claim 1, in which the said ends are positioned one above the other.

4. Method according to claim 1, characterized in that during the said fusion operation, the string is only in contact with the said ends.

5. Method according to claim 1, in which the duration of the said fusion operation is longer than 0.1 second.

6. Method according to claim 1, in which the fusion operation is carried out jointly by means of the string and by a second heat source.

7. Method according to claim 1, characterized in that during the said compression operation, the weld zone is pressed jointly along a perpendicular direction and a transverse direction to the direction of the said ends.

8. Method according to claim 1, characterized in that during the said compression operation, the string is spread and the thickness of the weld zone is reduced.

9. Method according to claim 1, characterized in that during the said compression operation, the said ends are pressed against one another.

10. Method according to claim 1, characterized in that during the said extrusion operation, the string is moved in a direction parallel to the elements of the device which support the laminate, so that the first contact of the string, once extruded, occurs directly with the laminate.

11. Fabrication method according to claim 9, in which the string is moved vertically in the direction of the force of gravity.

12. Method according to claim 1, characterized in that the string is deposited during the positioning operation.

13. Method according to claim 1, characterized in that the string is deposited following the positioning operation.

14. Tubular container obtained by a method as defined in claim 1.

15. Container according to claim 14, characterized in that at the weld, its thickness is less than twice the thickness of the laminate.

16. Device for carrying out a method as defined in claim 1, comprising a welding rod adapted to be surrounded by a laminate, means for extruding and placing a softened plastic string between the outer surface of the welding rod and a laminate placed around the said rod, characterized in that the welding rod is positioned vertically.

17. Device according to claim 15, further comprising a preheated conveyor belt positioned on the welding rod so that the said softened string is positioned between the said conveyor belt and a laminate surrounding the said rod.

18. Device according to either of claim 16, comprising an outer drive belt and an adjustable bearing pad positioned so as to apply, in the direction of the said welding rod, a pressure on a laminate and a softened plastic string which are positioned between the said drive belt and the said welding rod.

19. Device according to claim 16, in which the said means for extruding and positioning a softened plastic string are placed on the side of the upper face of the welding rod.

20. Device according to claim 16, in which the said means for extruding and positioning a softened plastic string are placed on the side of the lower face of the welding rod.
